(19) United States
(12) Patent Application Publication
(10) Pub. No.: US 2024/0351642 A1
(43) Pub. Date: Oct. 24, 2024

(54) Truck Bed Corner Reinforcement

(71) Applicant: Leer Group, Elkhart, IN (US)

(72) Inventor: Eugene A. Dylewski, II, Granger, IN (US)

(21) Appl. No.: 18/636,815

(22) Filed: Apr. 16, 2024

Related U.S. Application Data
(60) Provisional application No. 63/460,076, filed on Apr. 18, 2023.

(51) Int. Cl. B62D 33/023

(52) U.S. Cl. CPC B62D 33/023

(57) ABSTRACT

A truck bed corner reinforcement system is provided. The reinforcement bracket system is configured to attach to a corner of a cargo box of a truck to reinforce at least a portion of the cargo box. The reinforcement bracket system includes at least one reinforcement bracket assembly configured to attach to a portion of a sidewall and to a portion of a bulkhead. The reinforcement bracket has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on the sidewall.

### RELATED APPLICATIONS

The present application relates to and claims priority to U.S. Provisional Patent Application Ser. No. 63/460,076, filed on Apr. 18, 2023, entitled “Truck Bed Corner Reinforcement.” The subject matter disclosed in that Provisional application is hereby expressly incorporated into the present Application.

### TECHNICAL FIELD AND SUMMARY

The present disclosure relates to trucks, such as pickup trucks and like vehicles, with truck beds or cargo boxes installed thereon. In particular, the present disclosure relates to a corner reinforcement for a truck bed or cargo box cover, such as a cap, that fits over the cargo box.

A truck bed or cargo box is a large open space of a pickup truck located behind the truck's cab section. The cargo box is typically composed of a floor bounded by opposing sidewalls. A bulkhead extends between the opposed sidewalls and is located adjacent the cab section. A tailgate is located opposite the bulkhead at the rear end of the cargo box and is movable between open and closed positions.

A truck bed cap is an enclosure that attaches to the top sidewalls of a pickup truck's cargo box or truck bed. The truck cap includes upward extending side and forward walls, and a door typically positioned at the rearward end above the truck bed's tailgate (although the door can be placed anywhere on the cap). Typically, the upward extending walls terminate at the approximate height of the pickup truck's cab section roof. This configuration enhances the pickup truck's aesthetic appearance similar to a sport utility vehicle (SUV).

A typical sidewall for a cargo box may be composed of multiple formed sheets of metal, illustratively, including an outer sheet, inside sidewall sheet, and an inside sidewall rail. Such sidewalls may include more or less formed sheets of metal.

An issue that may exist with certain cargo boxes is that they might not have sufficient structural strength to support the weight of a truck cap. That weight might cause the metal at the corners, for example, to break, crack, or otherwise fail. This can obviously weaken the overall structural integrity of the cargo box. As such, a reinforcement could be useful to prevent this. Because it is typical for cargo boxes to have a myriad of accessory holes, some of which might be threaded, while some may not, they could nevertheless be used to secure reinforcements to the cargo box to enhance its structural strength. Therefore, depending on the manufacture of the cargo box, the accessory holes already disposed thereon may be employed to secure a reinforcement to the cargo box to alleviate potential damage thereto when a truck cap is placed thereon. A challenge for attaching reinforcements is that often sheets of metal that form the cargo box are stamped into shape and that shape is not always a flat surface that can accommodate a reinforcement bracket structure. Protrusions or obstacles in the surface of the cargo box, either on the sidewall or the bulkhead, can make attaching any kind of reinforcement previously untenable.

Another common feature on cargo box sidewalls is a top sidewall cap, often made of plastic, or like material. The sidewall cap fits on top of the top surface of the sidewall and often designed for aesthetic purposes. The sidewall caps are typically secured via fastening tabs molded to and extending from the underside of the sidewall cap. In addition, locating tabs and support ribs may be formed on the underside of the sidewall cap for purposes of installing and creating structural support to the sidewall cap.

This creates a challenge for conveniently securing a reinforcement to the cargo box because some of the accessory holes are placed underneath the sidewall cap. As a further complication, the sidewall cap fastening tabs may not be readily accessible to easily remove the sidewall cap from the top surface of the sidewall. Sidewall caps may be pried off, but that risks breaking them. Typically, the plastic used to make sidewall caps has some flexibility, but possibly not enough to prevent them from breaking when attempting to pry them off of the cargo box. Another complicating factor are sidewall cap support ribs that often exist on the underside of these sidewall caps. They are placed as needed for structural support of the sidewall cap itself, but may also create an obstruction at a location in proximity to the accessory holes formed in the top of the sidewalls, for example. Therefore, between the lack of planar surfaces on the cargo box at the areas that need reinforcement, in combination with the sidewall cap, reinforcement brackets may not have previously been viewed as a viable option to add the structural strength needed, particularly at the corners of the cargo box to support a truck cap.

Accordingly, an illustrative embodiment of the present disclosure provides a truck bed corner reinforcement system. The reinforcement bracket system is configured to attach to a corner of a cargo box of a truck to reinforce at least a portion of the cargo box. The reinforcement bracket system includes at least one reinforcement bracket assembly configured to attach to a portion of a sidewall and to a portion of a bulkhead. The at least one reinforcement bracket assembly includes a reinforcement bracket that has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on an upper facing surface of the sidewall underneath a top surface of a sidewall cap. The top angled portion is configured to be fastened to the upper facing surface of the sidewall underneath the top surface of the sidewall cap. A filler bracket includes a contoured surface. At least a portion of the contoured surface is configured to conform to a non-planar surface portion of either or both surface contours of the bulkhead or the sidewall. The filler bracket is located between the reinforcement bracket and the bulkhead and the sidewall. The filler bracket also includes a planar surface located opposite the contoured surface and which the reinforcement bracket abuts against. Also, the top angled portion extends from the first angled portion of the reinforcement bracket.

In the above and other embodiments, the truck bed corner reinforcement system may further comprise: the first angled portion and the second angled portion form an L-shaped reinforcement bracket; the top angled portion is configured to be fastened to one or more accessory holes disposed through the upper facing surface of the sidewall underneath the top surface of the sidewall cap; at least a portion of the filler bracket includes one or more irregular surface features that correspond to one or more irregular surface features on either or both the bulkhead and the sidewall; at least a portion of the filler bracket includes one or more openings that correspond to one or more openings through either or both the bulkhead and the sidewall; at least a portion of the filler bracket includes one or more scallops that correspond to one or more scallops on either or both the bulkhead and the sidewall; a thickness of the filler bracket is at least about the same or more than a thickness of one or more irregular surface features on either or both the bulkhead and the sidewall; the reinforcement bracket is welded to the filler bracket; the reinforcement bracket and the filler bracket include one or more aligned pre-tapped holes that coincide with one or more accessory holes in the cargo box to allow the reinforcement bracket and the filler bracket to be secured to the cargo box; a template that identifies a location of the one or more accessory holes in the cargo box; the top angled portion configured to be fastened to the upper facing surface of the sidewall underneath the top surface of the sidewall cap is also configured to align with one or more accessory holes on the upper facing surface of the sidewall; and one or more fasteners extend through one or more accessory holes formed through the sidewall cap, through the top angled portion, and thread into one or more accessory holes extended through the upper facing surface of the sidewall.

Another illustrative embodiment of the present disclosure provides a truck bed corner reinforcement system. The reinforcement bracket system is configured to attach to a corner of a cargo box of a truck to reinforce at least a portion of the cargo box. The reinforcement bracket system includes at least one reinforcement bracket assembly configured to attach to a portion of a sidewall and to a portion of a bulkhead. The at least one reinforcement bracket assembly includes a reinforcement bracket that has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on the sidewall. A filler bracket is located between the reinforcement bracket and the bulkhead and the sidewall. And the top angled portion extends from the first angled portion of the reinforcement bracket.

In the above and other embodiments, the truck bed corner reinforcement system may further comprise: the top angled portion is configured to be located on an upper facing surface of the sidewall underneath a top surface of a sidewall cap; the top angled portion is configured to be fastened to an upper facing surface of the sidewall underneath a top surface of a sidewall cap; the filler bracket includes a contoured surface; at least a portion of the contoured surface is configured to conform to a non-planar surface portion of either or both of the bulkhead or the sidewall that has surface contours; and the filler bracket includes a planar surface located opposite a contoured surface, which the reinforcement bracket abuts against.

Another illustrative embodiment of the present disclosure provides a truck bed corner reinforcement system. The reinforcement bracket system is configured to attach to a corner of a cargo box of a truck to reinforce at least a portion of the cargo box. The reinforcement bracket system includes at least one reinforcement bracket assembly configured to attach to a portion of a sidewall and to a portion of a bulkhead. The reinforcement bracket has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on the sidewall.

In the above and other embodiments, the truck bed corner reinforcement system may further comprise: a filler bracket, wherein the filler bracket is located between the reinforcement bracket and the bulkhead and the sidewall, and wherein the top angled portion extends from the first angled portion of the reinforcement bracket.

Additional features of the truck bed corner reinforcement will become apparent to those skilled in the art upon consideration of illustrative embodiments of carrying out the truck bed corner reinforcement as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, and clarity, the dimensions of some elements may be exaggerated relative to other elements. Further, where considered appropriate, reference labels may be repeated among the figures to indicate corresponding or analogous elements.

FIG. 1 is a detail perspective view of a portion of the front passenger side corner portion of a cargo box;

FIG. 2 is a perspective view of a reinforcement bracket system;

FIG. 3 is a perspective exploded view of the reinforcement bracket system;

FIG. 4 is a reverse perspective view of the reinforcement bracket system;

FIG. 5 is another detail perspective view of a portion of the passenger side corner of the cargo box, including sections of a sidewall and bulkhead;

FIG. 6 is another detail perspective view of the passenger side portion of the cargo box, including sections of the sidewall in the bulkhead;

FIG. 7 is another detail perspective view of a portion of the passenger side corner of the cargo box showing a sidewall cap positioned on the sidewall transverse to the bulkhead;

FIG. 8 is another detail perspective view of a portion of the passenger side corner of the cargo box showing the sidewall cap positioned on the sidewall transverse to the bulkhead;

FIG. 9 is another detail perspective view of a portion of the passenger side corner of the cargo box showing the sidewall cap positioned on the sidewall transverse to the bulkhead;

FIG. 10 is another detail perspective view of a portion of the passenger side corner of the cargo box showing the sidewall cap positioned on the sidewall transverse to the bulkhead;

FIG. 11 is another detail perspective view of a portion of the passenger side corner of the cargo box showing the sidewall cap positioned on the sidewall transverse to the bulkhead;

FIG. 12 is another detail perspective view of a portion of the passenger side corner of the cargo box with the sidewall cap in exploded view from the sidewall;

FIG. 13 is a rearward-looking cross-sectional view of a portion of the passenger side of the sidewall;

FIG. 14 is another rearward-looking cross-sectional view of a portion of the passenger side of the sidewall; and

FIG. 15 is a top detail perspective view of a portion of the passenger side corner of the cargo box with the sidewall cap shown in ghost view.

Corresponding reference characters indicate corresponding parts throughout the several views. The exemplification set out herein illustrates embodiments of the truck bed corner reinforcement, and such exemplification is not to be construed as limiting the scope of the truck bed corner reinforcement in any manner.

### DISCLOSURE OF ILLUSTRATIVE EMBODIMENTS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a reinforcement bracket system that can attach to the corner areas of a cargo box, particularly, the bulkhead end of the cargo box to reinforce that area sufficient to support a truck cap or cover such as a tonneau cover. Illustratively, an “L-shaped” reinforcement bracket system, as further described herein, may be employed to reinforce the cargo box. Such a reinforcement bracket system may include one or more reinforcement brackets that fasten to a portion of the sidewall, as well as to a portion of the bulkhead. This reinforcement bracket may include a first angled portion that can be attached to the sidewall of the cargo box. A second angled portion extending transverse to the first angled portion may be secured to the bulkhead. A top angled portion also extending transverse to the first angled portion may be slipped up underneath the sidewall cap and secured to accessory holes disposed through the top surface of the sidewall. To accommodate a potential non-planar surface of either or both of the bulkhead or sidewall, a filler bracket, portions of which may conform to the shape of the reinforcement bracket, may be positioned between the reinforcement bracket and the cargo box bulkhead and sidewall. Openings, scallops, or cutouts may also be strategically placed in the reinforcement bracket so as not to interfere with irregular surface features on either or both the bulkhead and/or sidewall. It is contemplated that the thickness of the filler bracket can be at least about the same as or more than the irregular surface features. This is so that when the reinforcement bracket is placed over the filler bracket, there is sufficient surface contact between the reinforcement bracket and the cargo box to provide the sufficient reinforcement of same to support a truck cap. Also, the reinforcement bracket can be shaped, such as having designated cut outs, for example, so as to avoid physical structures underneath the sidewall cap, such as the previously identified ribs. Furthermore, the reinforcement bracket can be spot welded or otherwise attached to the filler bracket.

In another illustrative embodiment, the reinforcement bracket system may have pre-tapped holes that coincide with accessory holes in the cargo box that allow the reinforcement bracket and filler bracket to be secured thereon. Because these accessory holes on the cargo box have predetermined locations and often times threaded, fasteners can be extended through both the reinforcement and filler brackets and threaded into the cargo box sidewall.

In instances where the accessory holes are underneath the sidewall cap, a template can be provided with the reinforcement bracket system for purposes of drilling holes through the sidewall cap to allow access to the accessory holes. The top angled portion extending from the first angled portion of the reinforcement bracket may be placed up underneath the sidewall cap with holes that fit over and align with the accessory holes on the top of the sidewall. One or more fasteners may extend through the holes drilled through the sidewall cap, through the top angled portion, and thread into the threaded accessory holes on the top of the sidewall.

In combination with additional holes disposed through the reinforcement bracket and filler bracket that align with other accessory holes in the bulkhead and/or sidewall, additional fasteners can be disposed therethrough to secure the reinforcement bracket system to the bulkhead and sidewall. The extra material provided by the reinforcement bracket system provided at one or more of the corners of the cargo box creates additional support to these corners sufficient to support a cargo box cover or truck cap.

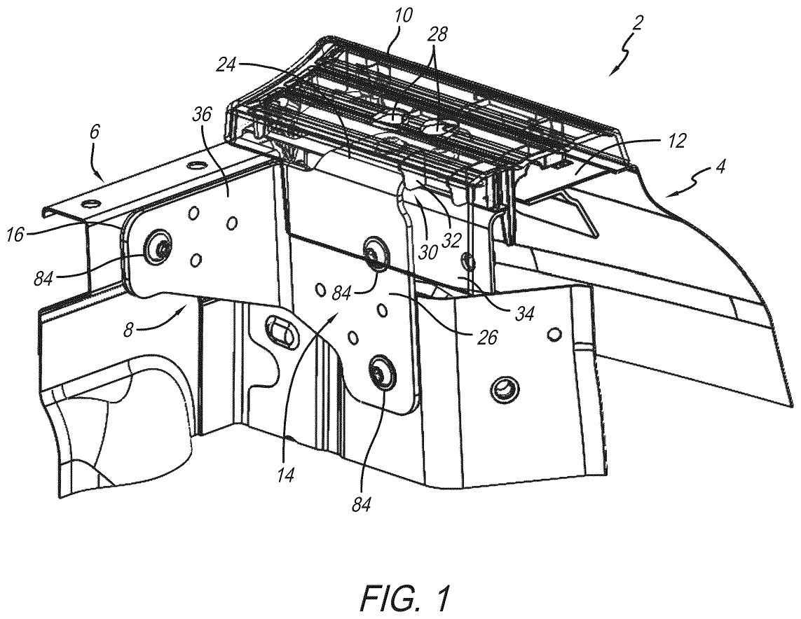

A detail perspective view of a portion of the front passenger side corner portion of cargo box 2, including sections of sidewall 4 and bulkhead 6, is shown in FIG. 1. Reinforcement bracket system 8 is positioned within the interior of cargo box 2 and attaches to both sidewall 4 and bulkhead 6 as illustratively shown. A sidewall cap 10 is shown located on top surface 12 of sidewall 4. As shown in this view, a portion of reinforcement bracket system 8 is located underneath sidewall cap 10, between it and top surface 12 of sidewall 4. With reinforcement bracket system 8, this portion of cargo box 2 is structurally strengthened sufficient to allow a truck cover, such as a truck cap, to be placed onto cargo box 2 without sidewall 4 and bulkhead 6.

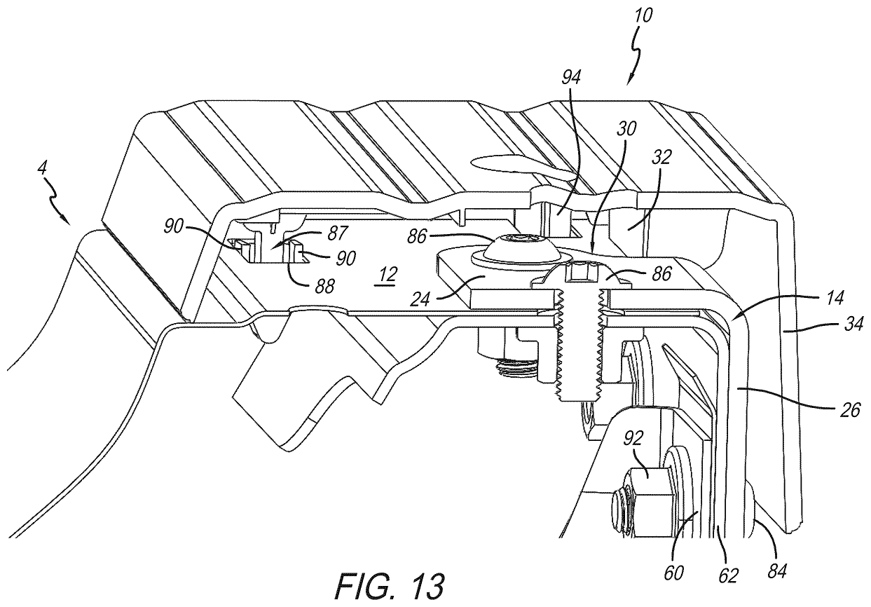

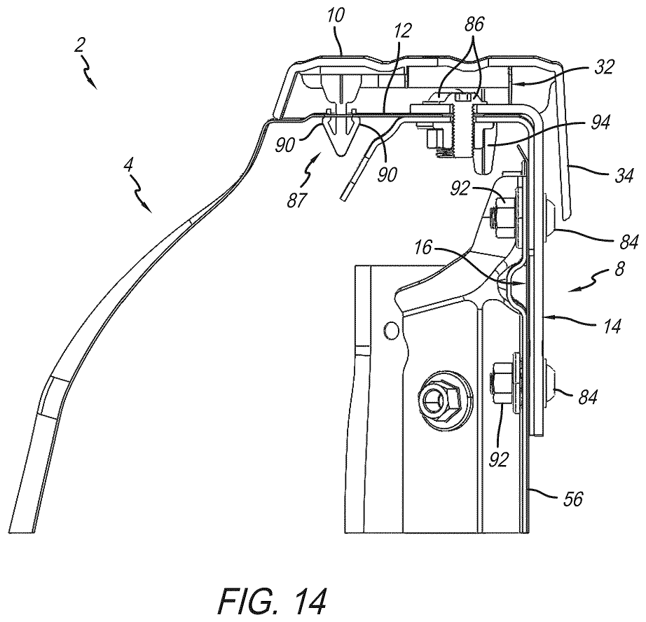

Reinforcement bracket system 8 illustratively includes a reinforcement bracket 14 positioned over top a filler bracket 16, secured against sidewall 4, and bulkhead 6, via fasteners 84. In this illustrative view, portions of sidewall cap 10 are shown in transparent view to demonstrate a top angle portion 24 extending transverse from sidewall angle portion 26. Top angle portion 24 is fitted between sidewall cap 10 and top surface 12 of sidewall 4. Fastener holes 28 are disposed through sidewall cap 10 to access accessory holes disposed through top surface 12 (see FIGS. 13 and 14) to further secure reinforcement bracket system 8 to cargo box 2.

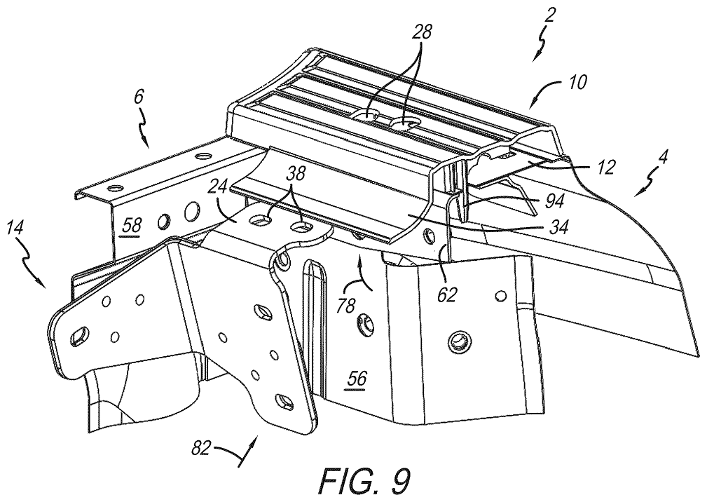

An illustrative scallop 30 may be formed between top angle portion 24 and sidewall angle portion 26 to avoid a rib 32 depending from the underside of sidewall cap 10. A portion of sidewall cap 10 includes a flap 34 that extends downward in the interior of cargo box 2. It is appreciated that a portion of sidewall angle portion 26, along with top angle portion 24, may be slipped up underneath flap 34 to position reinforcement bracket system 8, as shown (see FIG. 9). Also extending transverse from reinforcement bracket 14 is a bulkhead angle portion 36, which is secured to bulkhead 6 via fastener 84. Accordingly, the combination of top angle portion 24, sidewall angle portion 26, and bulkhead angle portion 36 of reinforcement bracket 14 of reinforcement bracket system 8, can be secured to sidewall 4 and bulkhead 6, thereby increasing the structural support of that portion of cargo box 2. It is noted that sidewall cap 10 does not need to be removed in order for reinforcement bracket 14 to be secured to sidewall 4.

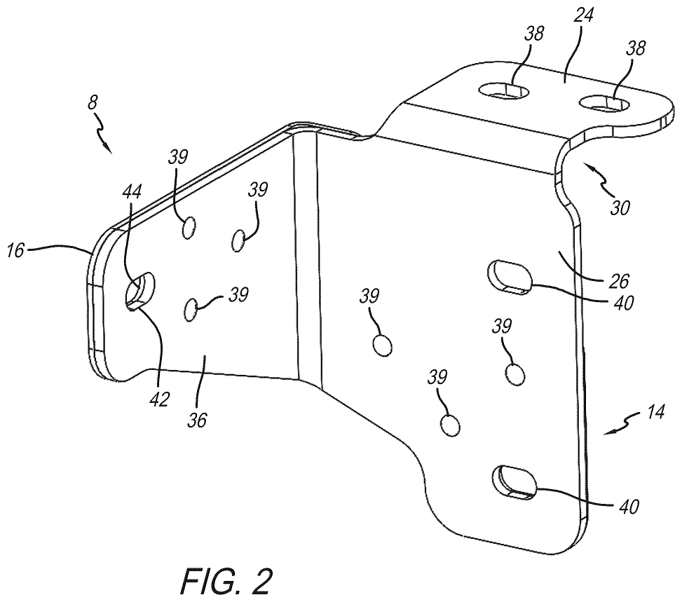

A perspective view of reinforcement bracket system 8 is shown in FIG. 2. Reinforcement bracket system 8 includes reinforcement bracket 14 and filler bracket 16. It is appreciated that at least a portion of filler bracket 16 may conform to the outline of reinforcement bracket 14, such as the portion adjacent bulkhead angle portion 36 illustratively shown. This view also shows top angle portion 24 extending transverse to sidewall angle portion 26. Scallop 30, located at least between portions of top angle portion 24 and sidewall angle portion 26, allows reinforcement bracket 14 to be placed in position while avoiding obstructions such as rib 32 formed on the underside of sidewall cap 10. It is appreciated that other scallops or cutouts may be placed on top angle portion 24 and/or sidewall angle portion 26, as needed, to avoid obstructions that may exist on the underside of sidewall cap 10.

One or more fastener holes 38 may be disposed through top angle portion 24 to receive fasteners that secure same to top surface 12 of sidewall 4. Sidewall angle portion 26 may likewise include fastener holes 40 that align with corresponding accessory holes in the sidewall to secure sidewall angled portion 26 thereto. Fastener hole 42, disposed through bulkhead angle portion 36, may align with both fastener hole 44, disposed through filler bracket 16, as well as an accessory hole in bulkhead 6 to secure bulkhead angle portion 36 to same. Additionally, spot weld points 39 on sidewall angled portion 26 and bulkhead angle portion 36 can secure reinforcement bracket 14 to filler bracket 16.

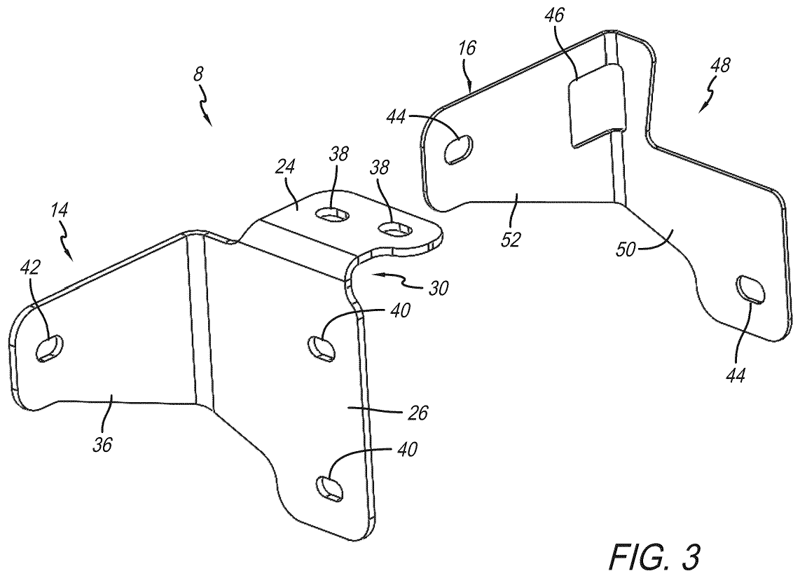

A perspective exploded view of reinforcement bracket system 8 is shown in FIG. 3. This view shows an illustrative configuration of filler bracket 16. Along with fastener hole 44, one or more openings 46 may be disposed therethrough in order to accommodate protrusions that exist in the surface of the bulkhead and/or sidewall 4. It is appreciated that the size and shape of the particular opening 46 is illustrative as it is dependent on the type of protrusion that exists in bulkhead 6 and/or sidewall 4. It is further appreciated that the size and shape of opening 46 may be changed, as well as additional openings added, depending on the surface of the structures filler bracket 16 will be placed onto. Such protrusions on cargo box 2 will be predetermined so such openings 46 of filler bracket 16 can be modified to the particular cargo box it will be attached to.

Another scallop 48 is formed in filler bracket 16, in this case, as part of a sidewall angled portion 50, which coincides to sidewall angle portion 26 of reinforcement bracket 14 so as to accommodate additional protrusions that exist on sidewall 4. Like reinforcement bracket 14, filler bracket 16 also includes a bulkhead angled portion 52 to conform to bulkhead angle portion 36 of reinforcement bracket 14. Another fastener hole 44 is disposed through sidewall angle portion 50 of filler bracket 16, which will align with fastener hole 40 of sidewall angle portion 26 of reinforcement bracket 14. It is contemplated that the thickness of filler bracket 16 provides an abutment surface for reinforcement bracket 14 to fit up against despite any protrusions that may exist in bulkhead 6 or sidewall 4.

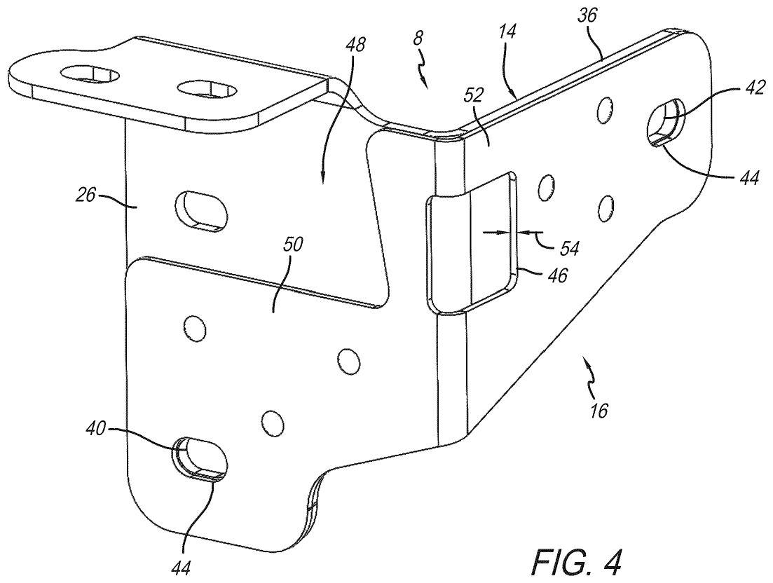

A reverse perspective view of reinforcement bracket system 8 is shown in FIG. 4. This view shows reinforcement bracket 14 positioned against filler bracket 16. It is appreciated that much of the outline of both reinforcement bracket 14 and filler bracket 16 coincide with each other. How fastener holes 40 and 42, of reinforcement bracket 14, align with corresponding fastener holes 44 of filler bracket 16, are illustratively shown. However, opening 46 disposed through filler bracket 16 is covered by portions of sidewall angled portion 26 and bulkhead angled portion 36 of reinforcement bracket 14. Similarly, scallop 48 of reinforcement bracket 14 is covered by sidewall angled portion 26. It is appreciated that protrusions that may extend outward from the surface of either or both of the bulkhead and/or sidewall may be positioned within opening 46 and/or scallop 48. It is contemplated that the thickness 54 of filler bracket 16 will be sufficient so that any surface protrusions or obstacles will not interfere with reinforcement bracket 14 abutting against fellow bracket 16. Again, it is contemplated that such scallops and openings of filler bracket 16 can be sized and configured to receive protrusions or obstructions of any variety typical of bulkhead and sidewall surfaces at the corner of cargo box 2.

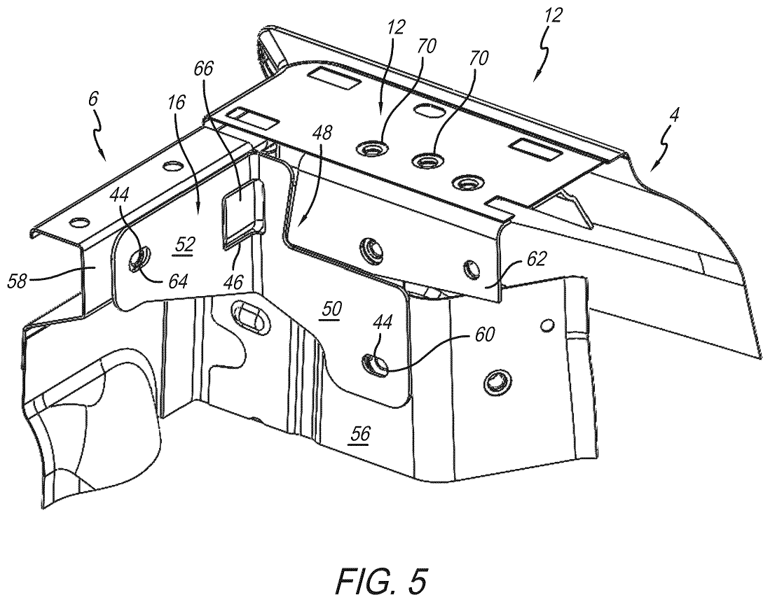

Another detail perspective view of a portion of the passenger side corner of cargo box 2, including sections of sidewall 4 and bulkhead 6, is shown in FIG. 5. Here, sidewall cap 10 has been removed to further show top surface 12 of sidewall 4. Filler bracket 16 is shown placed against panel 56 of sidewall 4, as well as panel 58 of bulkhead 6. Particularly, sidewall angled portion 50 of filler bracket 16 is positioned against panel 56. As shown, fastener hole 44 aligns with tapped hole 60 disposed through panel 56. It is appreciated that tapped hole 60 may be an accessory hole already pre-drilled within panel 56. Scallop 48 in sidewall angled portion 50 accommodates downturned lip 62 that is part of sidewall 4. It is appreciated that the size, shape, and thickness of scallop 48, along with any of the other openings and/or scallops, is made to accommodate such features like downturned lip 62 so that reinforcement bracket 14 has a flat surface to secure to.

Also shown in FIG. 5 is bulkhead angled portion 52 having fastener hole 44 disposed therethrough and aligned with a tapped hole 64 disposed through panel 58 of bulkhead 6. In this illustrative embodiment, tapped hole 64 is threaded in order to receive a fastener. Opening 46 is shown receiving protrusions 66, which is an irregular surface feature of, and extending from, panel 58. Like that discussed with respect to scallop 48, opening 46 may be shaped, sized, and have a thickness that accommodates such surface obstacles and protrusion like protrusion 66. It is further appreciated that other openings or holes may be disposed in either or both of sidewall angled portion 50 and/or bulkhead angled portion 52 in order to accommodate protrusions, obstacle, or irregularities, in the surface of bulkhead 6 or sidewall 4.

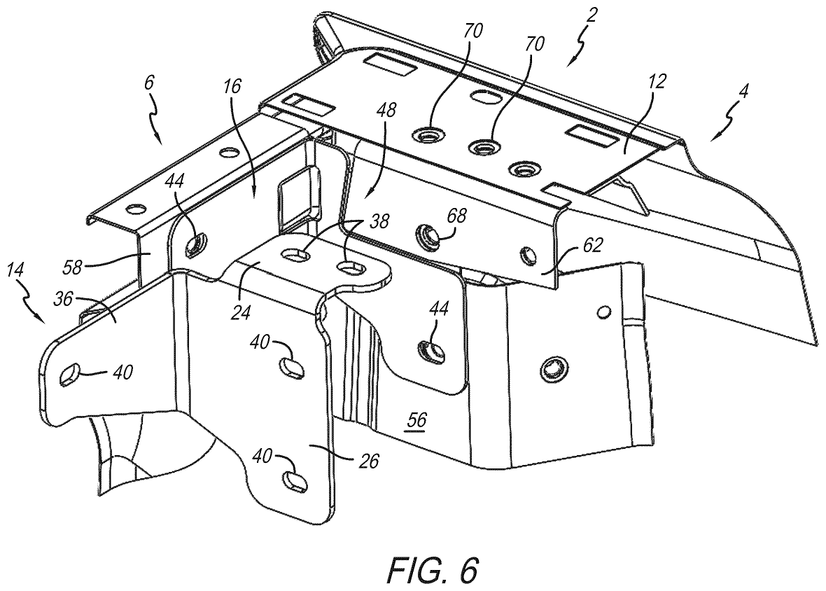

Another detail perspective view of the passenger side portion of cargo box 2, including sections of sidewall 4 and bulkhead 6, is shown in FIG. 6. This view is similar to that shown in FIG. 5, with filler bracket 16 positioned on panels 56 and 58, as illustratively shown. This view also shows reinforcement panel 14 in exploded view with respect to filler panel 16 and positioned to abut filler panel 16. Fastener holes 40 in sidewall angled portion 26 and bulkhead angled portion 36 are configured to align with fastener holes 44 disposed through filler brackets 16 and aligned with tapped holes 60, 64, and 68, respectively. As shown, tapped hole 68 is disposed through downturned lip 62. It is appreciated that tapped hole 68 may also be tapped so as to receive a threaded fastener. It is further appreciated that because downturned lip 62 extends from top surface 12 of sidewall 4, as shown, it fits within scallop 48 of reinforcement bracket 14 to provide a surface that at least a portion of which will abut a portion of sidewall angled portion 26 of reinforcement bracket 14.

This view also shows fastener holes 38 disposed through top angled portion 24 of reinforcement bracket 14. Fastener holes 38 are configured to align with tapped holes 70 disposed in top surface 12 of sidewall 4. This provides securement of reinforcement bracket 14, as well as filler bracket 16 on sidewall 4, bulkhead 6, and top surface 12. This assists in allowing reinforcement bracket 14 to carry an additional load in order to prevent the formed metal sheets of either or both sidewall 4 and bulkhead 6 from suffering failure under load from a truck cap or other structure sitting on top of cargo box 2. It is noted that sidewall cap 10 is not shown in this view. This is for demonstrative purposes only to show the positioning of tapped hole 70 in relation to other tapped holes and structures in FIGS. 5 and 6. It is contemplated, however, that during installation and operation of reinforcement bracket assembly 8, sidewall cap 10 will be in place as normal.

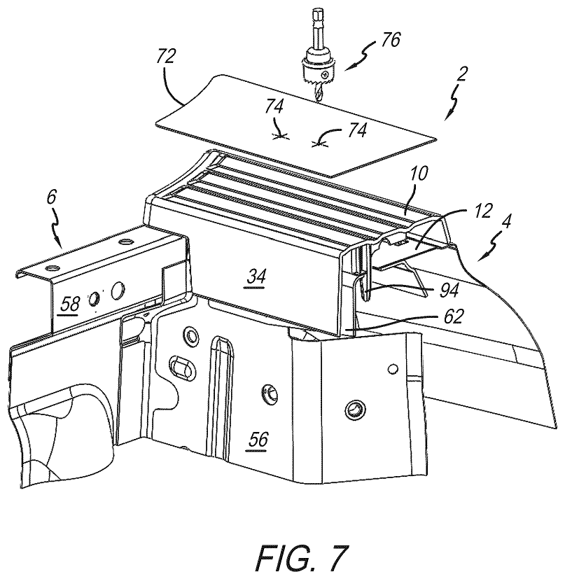

To that end, another detail perspective view of a portion of the passenger side corner of cargo box 2, including sidewall cap 10 positioned on sidewall 4 transverse to bulkhead 6, is shown in FIG. 7. Like that shown in FIG. 1, sidewall cap 10 is secured onto top surface 12 of sidewall 4 with flap 34 depending downward into the interior of cargo box 2. Also shown in this view is a template 72 that includes tap marks 74 that align with tapped holes 70 on top surface 12 when template 72 is positioned on sidewall cap 10. A drill with a boring bit 76, or the like, as shown, can drill a hole through template 72 at tap marks 74 and through cap 10 in order to expose tapped holes 70. This allows reinforcement bracket assembly 8 to be secured to top surface 12 of sidewall 4 without having to attempt removing sidewall cap 10 since that may result in damage to same.

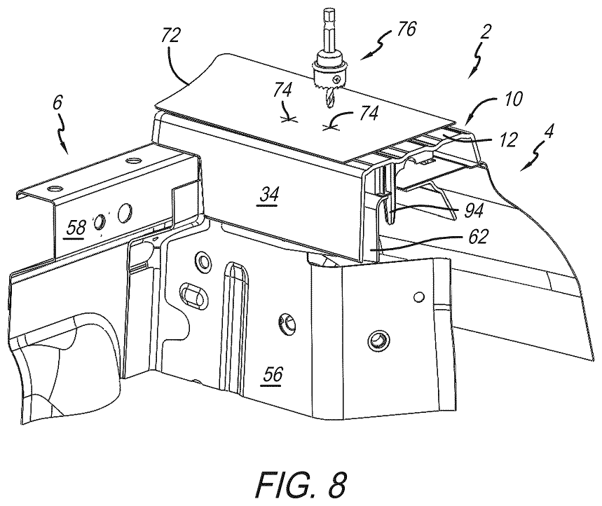

Another detail perspective view of a portion of the passenger side corner of cargo box 2, showing sidewall cap 10 positioned on sidewall 4 transverse to bulkhead 6, like FIG. 7, is shown in FIG. 8. A difference between this view and that of FIG. 7 is that template 72 has been placed on top of sidewall cap 10. When in this position, boring bit 76 can tap holes 28 at tap marks 74 on template 72 in sidewall cap 10. This view also demonstrates how flap 34 of sidewall 10 shrouds downturned lip 62 extending from top surface 12 of sidewall 4. With all the obstacles that sidewall cap 10 creates, it is conventional to try to remove the entire sidewall cap 10 prior to installing any reinforcement brackets. It is the intent of this present disclosure, however, to not require removal of sidewall cap 10 in order to nevertheless install reinforcement bracket system 8.

To that end, another detail perspective view of a portion of the passenger side corner of cargo box 2, with sidewall cap 10 positioned on sidewall 4 transverse to bulkhead 6, like FIGS. 7 and 8, is shown in FIG. 9. This view differs from FIG. 8 in that flap 34 is pivoted upward in direction 78 away from downturned lip 62 so that top angled portion 24 of reinforcement bracket 14 can be placed up on top of top surface 12 of sidewall 4 between flap 34 and downturned lip 62. Because sidewall caps are typically made of a plastic material, flaps, such as flap 34 shown herein, is flexible enough to be bent sufficient to insert top angled portion 24 between it and downturned lip 62. Top angled portion 24 can then be placed between top surface 12 of sidewall 4 and sidewall cap 10.

This view also shows an illustrative pair of fastener holes 80 disposed through sidewall cap 10. This is so that fasteners may extend through fastener holes 38 of top angled portion 24 of reinforcement bracket 14 to secure same to sidewall 4. It is appreciated that there can be a single fastener hole 80 or multiple fastener holes 80 based on the particular tapped hole arrangement on the sidewall as supplied by the pickup truck manufacturer. For the particular cargo box 2 shown herein, there happens to be two tapped holes 70 (see, e.g., FIG. 6) disposed in top surface 12 of sidewall 4. Reinforcement bracket 14, before secured to sidewall 4 or bulkhead 6, may be positioned at an angle similar to that shown, and in direction 78, to position it so that it can then be moved in direction 78, as previously described, to position top angled portion 24 up underneath sidewall cap 10 and set on top surface 12.

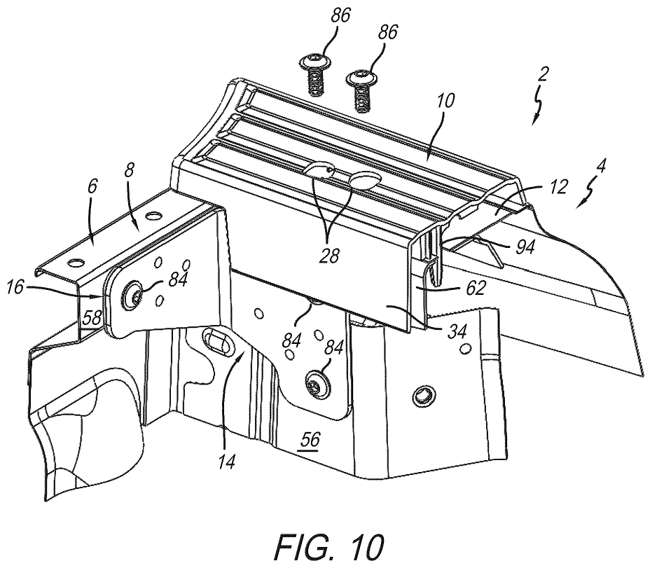

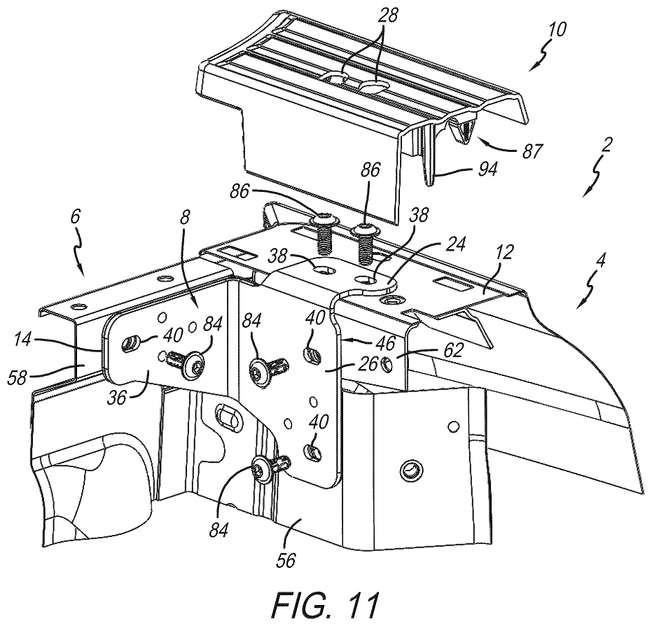

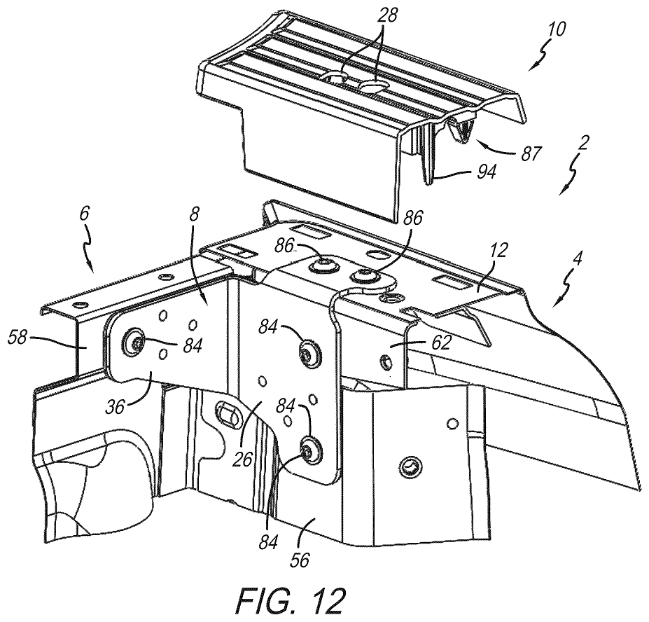

Another detail perspective view of a portion of the passenger side corner of cargo box 2, with sidewall cap 10 positioned on sidewall 4 transverse to bulkhead 6, like FIGS. 7, 8, and 9, is shown in FIG. 10. This view differs from the other figures in that in FIG. 10, reinforcement bracket system 8, including reinforcement bracket 14 and filler brackets 16, are positioned against bulkhead 6 and sidewall 4, respectively, and fastened into place via fasteners 84. Fastener holes 80 are disposed through sidewall cap 10 with additional fasteners 86 configured to extend therethrough and secure top angled portion 24 to top surface 12 of sidewall 4 (see, also, FIGS. 11 and 12). It is further appreciated from this view how reinforcement bracket assembly 8 is positioned behind flap 34 of sidewall cap 10. Except for fastener holes 80, sidewall cap 10 remains in place. There is no risk of breaking sidewall cap 10 trying to remove it to otherwise access tapped holes like tapped hole 70 on top surface 12 of sidewall 4 (see, also, FIG. 6). In most circumstances, when installing a truck cap or many types of cargo box covers, portions of sidewall cap 10 will be shrouded by the cap or cover in any event.

Another detail perspective view of a portion of the passenger side corner of cargo box 2, with sidewall 4 positioned transverse to bulkhead 6, like FIGS. 7, 8, 9, and 10, is shown in FIG. 11. This view differs from those other figures in that sidewall 4 is shown in partial exploded view with sidewall cap 10. It is appreciated that sidewall cap 10 is shown in exploded view for demonstrative purposes only to show how reinforcement bracket system 8 is secured to sidewall 4 and bulkhead 6. It is further appreciated, however, and as discussed previously, that in practice, sidewall cap 10 will not be removed.

As shown in this view, fasteners 84 extend through fastener holes, including fastener holes 40 through sidewall angled portion 26 and bulkhead angled portion 36, as well as the correspondingly aligned openings in filler panel 14, as well as the tapped holes in panel 56 of sidewall 4 and panel 58 of bulkhead 6. Similarly, fasteners 86 extend through fastener holes 38 disposed through top angled portion 24 and aligned with tapped holes 70. Fasteners 86 will be threaded into tapped holes 70 (see FIG. 6) securing reinforcement plate 16 not only against the sidewall and bulkhead panels 56 and 58, respectively, but also to top surface 12 of side panel 4. It is believed this provides enhanced structural strength to the corner of cargo box 2 without risking substantial damage to sidewall cap 10.

Another detail perspective view of a portion of the passenger side corner of cargo box 2, with sidewall cap 10 in illustrative exploded view from sidewall 4, is shown in FIG. 12. This view differs from that of FIG. 10 in that all of fasteners 84 and 86 are secured to respective tapped holes in either panel 56, 58, and top surface 12. At this point, reinforcement bracket system 8 is secured to cargo box 2 to help reinforce the corners of same.

A rearward-looking cross sectional view of a portion of the passenger side of sidewall 4 is shown in FIG. 13. This view shows sidewall cap 10 secured onto top surface 12 of sidewall 4 via fastener tabs, such as fastener tab 87 shown disposed through opening 88 in top surface 12. Typically, fastener tabs 87 have biasing arm members 90 that push away from fastener tab 87 so as to engage the periphery of opening 88 in top surface 12. Also shown depending from the underside of sidewall cap 10, is locating tab 94, as well as rib 32. It is because of rib 32 that scallop 30 was formed at top angled portion 24. Such support ribs like rib 32 may be necessary on the underside of sidewall cap 10 to provide the necessary structural support to same. Because sidewall cap 10 is not intended to be removed, reinforcement bracket system 8 and, particularly, reinforcement bracket 14, can be configured to avoid such obstacles.

Also shown is sidewall angled portion 26 positioned between flap 34 of sidewall cap 10 and flap 34 depending from top surface 12 of sidewall 4. Fastener 84 is shown disposed through tapped hole 60 and downturned lip 62. It is appreciated that these tapped holes may include a threaded body, such as nut 92, for purposes of threading fasteners, such as fastener 84 into nut 92, securing components together.

Another rearward-looking cross-sectional view of a portion of the passenger side of sidewall 4 is shown in FIG. 14. This view shows reinforcement bracket system 8 attached to panel 56 of sidewall 4 via fasteners 84 and 86. This view also demonstrates how reinforcement bracket 14 and filler bracket 16 secure to sidewall 4 at different positions (i.e., the side and top) of sidewall 4. This view further shows that reinforcement bracket 8 is positioned below and behind flap 34 of sidewall cap 10. It is appreciated that because sidewall cap 10 is secured onto top surface 12 of sidewall 4 via fastening tab 87, it is important for the reinforcement bracket system 8 to secure to sidewall 4, but without attempting to remove sidewall cap 10, which could result in damaging same. Nuts 92 are also shown as the threaded backing for the openings in sidewall 4.

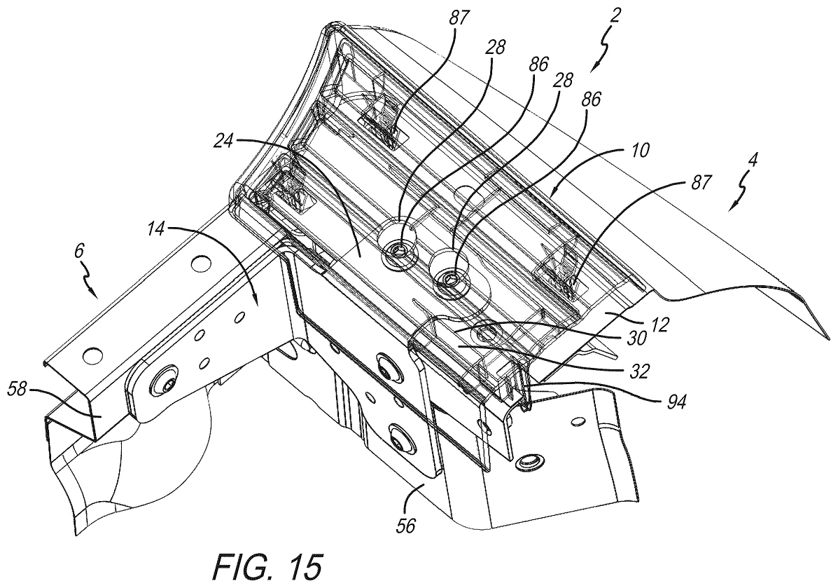

A top detail perspective view of a portion of the passenger side corner of cargo box 2, with sidewall cap 10 included in ghost view, is shown in FIG. 15. This view demonstrates how fasteners 86 can be disposed through fastener holes 28 to secure top angled portion 24 from reinforcement bracket 14 onto top surface 12 of sidewall 4. Also shown, is the need for scallop 30, from top angled portion 24, to avoid rib 32, which would otherwise interfere with the ability of top angled portion 24 to be positioned onto top surface 12. This also demonstrates that it is appreciated in this present disclosure and that such scallops, openings, car routes, etc. may be formed on the periphery or internally within reinforcement bracket 14 and/or filler bracket 16 in order to accommodate obstacles from both the sidewall cap 10, as well as surfaces 56 and 58 of sidewall 4 and bulkhead 6, respectively, that need to be avoided. Reinforcement bracket system 8 can be effectively deployed with such scallops, openings, car routes, etc., while still providing a reinforcement function to cargo box 2.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. A reinforcement bracket system configured to attach to a corner of a cargo box of a truck to reinforce at least a portion of the cargo box, the reinforcement bracket system comprising:
at least one reinforcement bracket assembly configured to attach to a portion of a sidewall and to a portion of a bulkhead, the at least one reinforcement bracket assembly includes:
a reinforcement bracket that has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on an upper facing surface of the sidewall underneath a top surface of a sidewall cap;
wherein the top angled portion is configured to be fastened to the upper facing surface of the sidewall underneath the top surface of the sidewall cap; and
a filler bracket that includes a contoured surface;
wherein at least a portion of the contoured surface is configured to conform to a non-planar surface portion of either or both surface contours of the bulkhead or the sidewall;
wherein the filler bracket is located between the reinforcement bracket and the bulkhead and the sidewall;
wherein the filler bracket includes a planar surface located opposite the contoured surface and which the reinforcement bracket abuts against; and
wherein the top angled portion extends from the first angled portion of the reinforcement bracket.

2. The reinforcement bracket system of claim 1, wherein the first angled portion and the second angled portion form an L-shaped reinforcement bracket.

3. The reinforcement bracket system of claim 1, wherein the top angled portion is configured to be fastened to one or more accessory holes disposed through the upper facing surface of the sidewall underneath the top surface of the sidewall cap.

4. The reinforcement bracket system of claim 1, wherein at least a portion of the filler bracket includes one or more irregular surface features that correspond to one or more irregular surface features on either or both the bulkhead and the sidewall.

5. The reinforcement bracket system of claim 1, wherein at least a portion of the filler bracket includes one or more openings that correspond to one or more openings through either or both the bulkhead and the sidewall.

6. The reinforcement bracket system of claim 1, wherein at least a portion of the filler bracket includes one or more scallops that correspond to one or more scallops on either or both the bulkhead and the sidewall.

7. The reinforcement bracket system of claim 4, wherein a thickness of the filler bracket is at least about the same or more than a thickness of one or more irregular surface features on either or both the bulkhead and the sidewall.

8. The reinforcement bracket system of claim 1, wherein the reinforcement bracket is welded to the filler bracket.

9. The reinforcement bracket system of claim 1, wherein the reinforcement bracket and the filler bracket include one or more aligned pre-tapped holes that coincide with one or more accessory holes in the cargo box to allow the reinforcement bracket and the filler bracket to be secured to the cargo box.

10. The reinforcement bracket system of claim 9, further comprising a template that identifies a location of the one or more accessory holes in the cargo box.

11. The reinforcement bracket system of claim 1, wherein the top angled portion configured to be fastened to the upper facing surface of the sidewall underneath the top surface of the sidewall cap is also configured to align with one or more accessory holes on the upper facing surface of the sidewall.

12. The reinforcement bracket system of claim 1, wherein one or more fasteners extend through one or more accessory holes formed through the sidewall cap, through the top angled portion, and thread into one or more accessory holes extended through the upper facing surface of the sidewall.

13. A reinforcement bracket system configured to attach to a corner of a cargo box of a truck to reinforce at least a portion of the cargo box, the reinforcement bracket system comprising:
at least one reinforcement bracket assembly configured to attach to a portion of a sidewall and to a portion of a bulkhead, the at least one reinforcement bracket assembly includes:
a reinforcement bracket that has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on the sidewall; and
a filler bracket;
wherein the filler bracket is located between the reinforcement bracket and the bulkhead and the sidewall; and
wherein the top angled portion extends from the first angled portion of the reinforcement bracket.

14. The reinforcement bracket system of claim 13, wherein the top angled portion is configured to be located on an upper facing surface of the sidewall underneath a top surface of a sidewall cap.

15. The reinforcement bracket system of claim 13, wherein the top angled portion is configured to be fastened to an upper facing surface of the sidewall underneath a top surface of a sidewall cap.

16. The reinforcement bracket system of claim 13, wherein the filler bracket includes a contoured surface.

17. The reinforcement bracket system of claim 16, wherein at least a portion of the contoured surface is configured to conform to a non-planar surface portion of either or both of the bulkhead or the sidewall that has surface contours.

18. The reinforcement bracket system of claim 13, wherein the filler bracket includes a planar surface located opposite a contoured surface and which the reinforcement bracket abuts against.

19. A reinforcement bracket system configured to attach to a corner of a cargo box of a truck to reinforce at least a portion of the cargo box, the reinforcement bracket system comprising:
at least one reinforcement bracket assembly configured to attach to a portion of a sidewall and to a portion of a bulkhead, the at least one reinforcement bracket assembly includes:
a reinforcement bracket that has a first angled portion configured to be attached to the sidewall of the cargo box, a second angled portion extending transverse to the first angled portion and configured to be secured to the bulkhead of the cargo box, and a top angled portion extending transverse to the first angled portion and configured to be located on the sidewall.

20. The reinforcement bracket system of claim 19, further comprising a filler bracket, wherein the filler bracket is located between the reinforcement bracket and the bulkhead and the sidewall, and wherein the top angled portion extends from the first angled portion of the reinforcement bracket.
